(19) United States
(12) Patent Application Publication
(10) Pub. No.: US 2014/0089454 A1
(43) Pub. Date: Mar. 27, 2014

(54) METHOD FOR MANAGING CONTENT CACHING BASED ON HOP COUNT AND NETWORK ENTITY THEREOF

(71) Applicant: Electronics and Telecommunications Research Institute, Daejeon (KR)

(72) Inventors: Hong Seok JEON, Daejeon (KR); Byung Joon LEE, Daejeon (KR); Ho Young SONG, Daejeon (KR); Seung Hyun YOON, Daejeon (KR)

(73) Assignee: Electronics and Telecommunications Research Institute, Daejeon (KR)

(21) Appl. No.: 14/029,596

(22) Filed: Sep. 17, 2013

(30) Foreign Application Priority Data
Sep. 21, 2012 (KR) 10-2012-0104955

(51) Int. Cl. H04L 29/08

(52) U.S. Cl. CPC H04L 67/2842
USPC 709/213

(57) ABSTRACT

Disclosed is hop-count based content caching. The present invention implements hop-count based content cache placement strategies that efficiently decrease traffics of a network by the routing node's primarily judging whether to cache a content chunk by grasping an attribute of the received content chunk; the routing node's secondarily judging whether to cache the content chunk based on a caching probability of ‘1/hop count’; and storing the content chunk and the hop count information in the cache memory of the routing node when the content chunk is determined to cache the content chunk as a result of the secondary judgment.

### CROSS-REFERENCE TO RELATED APPLICATIONS

This application claims priority to and the benefit of Korean Patent Application No. 10-2012-0104955 filed in the Korean Intellectual Property Office on Sep. 21, 2012, the entire contents of which are incorporated herein by reference.

### TECHNICAL FIELD

The present invention relates to content caching, and more particularly, to content caching based on hop count.

### BACKGROUND

In a data service using an Internet network, a customer's request for a service associated with a content distribution infrastructure capable of providing large scale content has increased. The phenomenon causes an increase of content data amount, which the network will service, and an increase of traffic of the network. In order to prevent the traffic from being increased, various solutions to decrease the network traffic by storing a copy of the content around a client have been proposed. As one example of the solutions, data services such as peer-to-peer (P2P) and content distribution networks (CND) have been popularized. However, the related arts are just at an application level or temporary measures for decreasing the traffic and have technical limits in that contents and services which are explosively increased cannot be fundamentally handled.

Meanwhile, the structure of the Internet is originally designed for an interhost communication service while today, the Internet is generally used to unilaterally access contents. That is, there is a technical gap between an actual design purpose of the Internet and the use thereof. The technical phenomenon leads to a study about a new content-centric Internet structure. As a result of recent study, a future Internet structure of a clean-slate approach such as content centric networking (CCN) or data-oriented network architecture (DONA) has been proposed. One of features which the new content-based Internet structures commonly propose is supporting on-path caching.

The on-path caching is one of in-network caching methods in which routing nodes (for example, routers) positioned on a transmission channel of contents in the network temporarily cache and store contents and thereafter, provide the corresponding contents from their own caching memories when receiving a request for the same contents afterwards.

Meanwhile, a content cache placement strategy indicates a method of deciding which content is cached. A basic content cache placement strategy includes an ‘ALWAYS strategy’ that caches all received contents and a ‘fixed probability based strategy’ that decides whether to cache contents received with a fixed probability value. As one example, for example, a 10% fixed probability based strategy is a method in which when a predetermined routing node of the network receives 10 content packets, the routing node selects and caches only one content packet among them. However, in the case of the ‘fixed probability based strategy’, a required fixed probability may depend on the shape of the network and a feature of the content and an optimal fixed probability may be known only through Empirical study. However, when the shape of the network and the feature of the content are changed in real time, there is a technical limit that it is difficult to find the optimal fixed probability value.

Meanwhile, as another example of content cache placement strategy, in the case of the ‘ALWAYS strategy’, when a caching memory of the routing node is relatively small as compared to the amount of distributed contents, bad performance is shown. Since all of the received contents are cached regardless of a use frequency of the content, a frequency cache replacement operation is caused and predetermined content packets monopolize limited caching memories of the routing nodes. Accordingly, various content packets are not distributed throughout the network, and as a result, the caching memories of the routing nodes cannot be efficiently used.

### SUMMARY

The present invention has been made in an effort to provide a content cache placement strategy based on hop count information.

That is, in a content cache placement strategy in a network, a ‘fixed probability based strategy’ or an ‘ALWAYS strategy’ is not just applied to a network structure but each routing node decides whether a content chunk is cached by applying a caching probability of a ‘1/hop count value’ by using hop count information to effectively cache contents which are encoded with various resolutions by considering a situation of user equipment (UE) and a situation of an access network.

An exemplary embodiment of the present invention provides a method for caching content in a network, including:

(A) primarily judging whether to cache a content chunk by grasping an attribute of the content chunk;

(B) acquiring a caching probability by extracting hop count information from the content chunk judged to be cached in the primary judgment; and

(C) secondarily judging whether to cache the content chunk based on the acquired caching probability.

The method may further include (D) storing the content chunk in a cache memory of a routing node when it is determined that the content chunk is to be cached as a result of the judgment in step (C).

The hop count information corresponding to the content chunk may be stored in the cache memory of the routing node together.

The method may further include forwarding the content chunk to a downstream network node when the routing node determines to cache the received content chunk.

In step (A), the content chunk may be a part of a packet that transfers content, received from an upstream routing node or a content server.

The hop count information may indicate a hop count value of the content chunk, and the caching probability may be a ‘1/hop count’.

The hop count information may be acquired from a value indicated by a hop count field of a packet that transfers content including the content chunk.

Step (A) may include:

judging whether the content chunk is a target to cache by using attribute information included in the packet that transfers content;

judging whether the received content chunk is a packet that transfers general content or a control message;

judging whether the received content chunk is a packet that transfers real-time interactive content; and

judging whether the received content chunk is a packet that transfers content of a personal content.

Another exemplary embodiment of the present invention provides a network entity, in a network system, in order to transmit/receive content by the unit of a chunk and implement a content caching placement method, including a plurality of content servers; a plurality of routing nodes; and a plurality of user equipments,

wherein the routing nodes includes program modules of,

(a) primarily judging whether to cache a content chunk by grasping an attribute of a content chunk received from an upstream routing node or a content server;

(b) acquiring a caching probability by extracting hop count information from the content chunk judged to be cached in the primary judgment;

(c) secondarily judging whether to cache the content chunk based on the acquired caching probability; and

(d) storing the content chunk and the hop count information in a cache memory of a routing node when it is determined that the content chunk is to be cached as a result of the judgment in step (C).

According to the exemplary embodiments of the present invention, a caching probability of a content chunk is decided by using hop count information of the received content chunk, and as a result, a reuse degree for the content chunk can be anticipated in advance in terms of a network structure, and a content chunk having a high reuse degree can be effectively cached.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram for describing a configuration of the present invention according to an exemplary embodiment of the present invention.

FIG. 2 is a block diagram illustrating a full binary tree type network structure according to an exemplary embodiment of the present invention.

FIG. 3 is a flowchart illustrating a method of caching a content chunk based on hop count according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

The present invention is applied to a network using a content cache placement strategy and a system thereof. However, the present invention is not limited thereto and may be applied all technical fields to which a technical spirit of the present invention can be applied.

A basic concept of the present invention is to effectively cache contents by using the extracted hop count information from a content chunk in a network applied with a content cache placement strategy and a system thereof.

In order to implement the basic concept of the present invention, the present invention implements hop-count based content cache placement strategies that efficiently decrease traffics of a network by 1) a routing nod's primarily judging whether to cache a content chunk by grasping a content attribute of the received content chunk; 2) the routing node's secondarily judging whether to cache the content chunk based on a caching probability of ‘1/hop count’; and 3) storing the content chunk and the hop count information in the cache memory of the routing node when the content chunk is determined to cache the content chunk as a result of the secondary judgment.

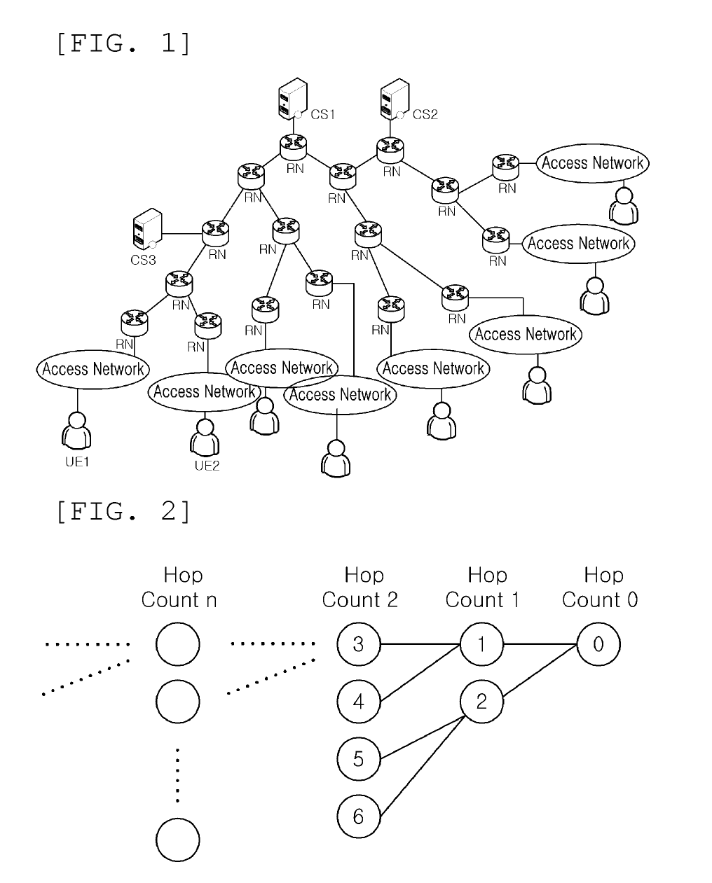

FIG. 1 is a diagram for describing a configuration of the present invention according to an exemplary embodiment of the present invention. Meanwhile, FIG. 1 illustrates network entities (that is, a content server, a routing node, and user equipment) of which the number is arbitrarily determined for easy description. Therefore, in the present invention, networks having various hierarchical structures may be configured in accordance with a feature of a network and a customer's request. It is assumed that data is transmitted and received between the content server and the user equipment by the unit of a chunk, in the network structure of FIG. 1.

As illustrated in FIG. 1, a network structure in which a content cache placement strategy according to the present invention is implemented includes one or more network entities. That is, the network structure includes one or more content servers (CS), one or more routing nodes (RN), and one or more user equipments (UE).

The content server as a server that stores contents and provides the stored contents to the user terminal UE includes an original server providing original content and/or a cache server providing copy content. Meanwhile, the content server may include one or more cache servers, and the cache server may be configured to be separated from the content server as one independent constituent member. The content server divides the content into chunk units having a predetermined size and transmits the divided contents to the user equipment through the routing node.

The routing node is positioned between the user equipment and the content server and serves to transfer a request for the content from the user equipment to the corresponding content server and transfer the content of the content server to the user. Therefore, the routing node is an object in which requests for contents from the user equipments are aggregated in the network. As illustrated in FIG. 1, it may be intuitively appreciated that the size of the aggregation may be larger as the routing node is closer to the content server. The routing node supports an on-path caching function for content chunks. Each routing node includes a module (or a control unit or a processing unit) determining whether the content (that is, content chunk) received from the server is a target to cache and a cache memory storing content information (for example, content server information and hop count information) of the target to cache.

Meanwhile, the user equipment is an entity that accesses the routing node through an access network, requests the content to the content server, and receives the requested content from the content server through the routing node and consumes the received content.

Hereinafter, referring to FIG. 1, a content cache placement strategy using the hop count according to the present invention will be described.

As illustrated in FIG. 1, the routing node gathers requests for contents of the user equipments in a network having a tree structure. Each routing node receives the content chunk from the content server. In this case, content chunks received from a close content server among content chunks which the routing node receives from the content server are reused with a higher probability than that of content chunks received from a farther content server. For example, it is assumed that in FIG. 1, RN1 receives content 1, content 2, and content 3 from CS1, CS2, and CS3, respectively. In this case, in RN1, content 3 received from CS3 which is the closest content server is reused with the highest probability.

In relation to the routing node, content which is requested from the user equipment with a high frequency will be content which a content server closest to the routing node provides. A probability that a predetermined content is reused is associated with a relative distance from a current location (for example, RN1 in FIG. 1) of a predetermined routing node to each content server (that is, CS1, CS2, or CS3 in FIG. 1). The association may be applied to the hop count. The hop count represents a distance (that is, a logical distance) between a predetermined routing node and each content server. The routing node according to the present invention determines whether to store information on a predetermined content in the cache memory by using the hop count. Therefore, the routing node of the network according to the present invention may apply the content cache placement strategy by considering situations (or capabilities) of the user equipment and the network by means of the hop count.

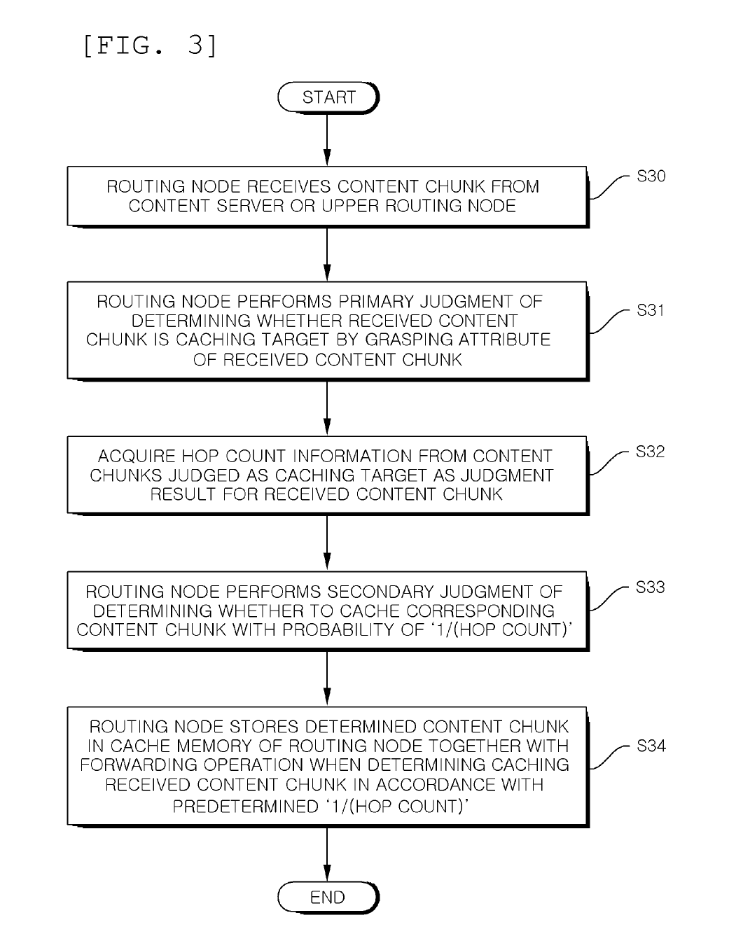

FIG. 2 is a block diagram illustrating a full binary tree type network structure according to an exemplary embodiment of the present invention. In a full binary tree of FIG. 2, a root node (node-0 in FIG. 2) represents the content server and not the root node but internal nodes represent the routing nodes and leaf nodes represent the user equipments.

In the network structure of FIG. 2, the hop count from the content server to each routing node is the same as a level at which each routing node is positioned in the full binary tree structure. For example, hop counts of routing nodes (node-1 and node-2) at level 1 are 1 and hop counts of routing nodes (nodes-3 to 6) at level 2 are all 2. The number of leaf nodes which internal nodes positioned at level n have is 2(^{full binary tree}^{_{—}}^{level}^{ₙ}) by a feature of the full binary tree. Therefore, the numbers of the leaf nodes which the internal nodes positioned at level 1 and level 2 in a full binary tree having a depth of 16 are 32,768 and 16,384, respectively and this means that the numbers of the user equipments which the routing nodes positioned at the hop count 1 and the hop count 2 in the network structure of the full binary tree type having the depth of 16 are 32,768 and 16,384, respectively. As such, a routing node which is positioned at a hop count having a smaller number has more use equipments therebelow and as a result, may receive requests from more user equipments. In other words, consequently, a possibility that a content chunk transmitted from the content server via a longer path will be referred to by the user terminal is low. Therefore, a hop-count based cache placement strategy according to the present invention is defined as caching a reference probability of the content chunks of ‘1/hop count’.

Hereafter, a method for the routing node to acquire hop count information according to the present invention will be described.

1) Method to acquire hop count information by using a Time To Live (TTL) value of Internet protocol (IP) datagram;

In the case where the content chunks are received through the Internet, the routing node acquires hop count information by using a Time To Live (TTL) value of a received IP datagram. That is, a decrease value of the TTL value which is a result of subtracting a received current TTL value from an initial TTL value is used as the hop count. That is, the hop count is expressed by an equation as follows; “hop count in predetermined routing node”=“initial TTL value of IP datagram”−“received current TTL value of IP datagram”

When the routing nodes cache the content chunks received from the content server through the IP datagram, the routing nodes record decrease values of the received TTL values together. In the case where the routing nodes have the content requested by the user equipment in a cache type, the routing nodes directly provide the content requested through the IP datagram to the user equipment. In this case, as the TTL value of the IP datagram, the TTL value recorded at the time of receiving the corresponding content in advance is used. However, when the IP datagram is sent from the content server, the initial TTL value depends on a type of an operating system of the content server (Window: 128, Linux: 64, and other OS: 255), and as a result, when the operating systems of the content servers are different from each other, it is inappropriate to use the TTL value as it is. However, in this case, an appropriate correction algorithm may be used together.

2) Method to add hop count information to a packet that transfers content by explicit extension;

The exemplary embodiment of the present invention is another exemplary embodiment in which hop count information is explicitly included in a packet that transfers content. That is, in a structure of the packet that transfers content, a field (alternatively, an element) corresponding to the hop count information is included in header information of the packet. Therefore, when the content server transmits the content chunk, the hop count information may be explicitly specified in the packet that transfers content.

For example, in a content centric network (CCN) which is a new Internet structure of a representative content transfer purpose, the hop count information may be added to a data packet which is a message packet which a predetermined network node (routing node or content server) having the content which the user equipment requests transmits requested data as a response.

That is, when the content server transmits the data packet to the network node (for example, the routing node), the content server sets an initial value (‘0’ or ‘1’) of a hop count field. Whenever each of the routing nodes receives the data packet from the content server or an upstream routing node and thereafter, transfers the received data packet to a downstream routing node, each of the routing nodes increases a value of the hop count field one by one. When each routing node caches the content chunk received through the data packet, each routing node records the hop count value in the cache memory together with content chunk information to be cached by referring to the hop count field of the data packet. For example, when the hop count value is small, both the content chunk (alternatively, the content chunk information) and the hop count are stored in the cache memory with a high probability.

In the case where the routing node has the content requested by the user equipment in the cache type, the routing node directly provides the requested content to the user equipment through the data packet and the recorded hop count value at the time of receiving the corresponding content in advance is used as a hop count field value of the generated data packet.

Hereinafter, the content cache placement strategy of the present invention will be described with reference to FIG. 3.

FIG. 3 is a flowchart illustrating a method of caching a content chunk based on hop count according to an exemplary embodiment of the present invention. FIG. 3 describes the method for the routing nodes to cache the received content chunks based on the hop count according to the exemplary embodiment of the present invention.

The routing node receives a content chunk from a content server or an upstream routing node (S30). In this case, the content chunk may be included in a packet that transfers content (for example, a data packet in a CCN) to be transmitted. The packet that transfers content may further include a hop count field.

The routing node performs primary judgment of determining whether the content chunk is to be cached by grasping an attribute of the received content chunk (S31). In this case, the routing node may judge whether the content chunk is to be cached by using attribute information included in the packet that transfers content. That is, in step S31, the routing node judges that the content chunk is a target to cache when the received content chunk is a packet that transfers general content and the content chunk is not a target to cache when the received content chunk is a control message.

In step S31, even though the routing node judges that the received content chunk is a packet that transfers general content, the routing node judges whether the received content chunk is a real-time interactive packet that transfers content and even in the case where the received content chunk is the packet that transfers real-time interactive content, the received content chunk is excluded from a target to cache. For example, in the case of the packet that transfers content, generated in a VoIP based Internet telephone call, the routing node classifies the packet that transfers content as the packet that transfers real-time interactive content and excludes the packet that transfers content from the target to cache. In step S31, the routing node excludes a packet that transfers content of a personal content such as a point-to-point communication from the target to cache and excludes even an encrypted packet that transfers content or a packet that transfers content which is required to be certified from the target to cache.

In step S31, in the case where the routing node judges that the received content chunk is not the target to cache, the routing node forwards the received content chunk to a downstream or an upstream node based on routing information (that is, one information with the packet that transfers content including the content chunk) without caching.

Hop count information is acquired from the received content chunk which is determined as the target to cache in accordance with the judgment result in step S31 (S32). In the case where the hop count information is included in the packet that transfers content in S31, the routing node extracts the hop count information (that is, a hop count value corresponding to the content chunk) from a hop count field of the packet that transfers content (that is, a packet including the received content chunk).

The routing node performs secondary judgment of determining whether the content chunk is to be cached with a probability of ‘1/(hop count)’ (S33). In step S33, when the hop count value is small, it is meant that the received content chunk is received from a neighboring content server and it is meant that a request probability for the content chunk from the user equipment is high. Therefore, the small hop count value means that a caching probability of the content chunk needs to be increased. According to the present invention, whether the content chunk is to be cached is determined with a probability value of ‘1/(hop count)’ in the secondary judgment.

In step S33, in the case where the routing node determines not to cache the content chunk as the secondary judgment result, the content chunk is forwarded to the corresponding network node based on the routing information without caching.

On the contrary, in accordance with the secondary judgment result of step S33, when the routing node determines caching the received content chunk in accordance with a predetermined ‘1/(hop count value)’, the determined content chunk is stored in the cache memory of the routing node together with a forwarding operation (S34). In this case, when the content chunk is stored in the cache memory, the hop count information may also be stored together.

As described above, in the present invention, the routing node performs the secondary judgment of determining whether the content chunk included in the target to cache in the aforementioned primary judgment is cached again probabilistically. In particular, the secondary judgment is a caching method with a higher probability as the hop count value of the content chunk is smaller.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for caching content in a network, comprising:
primarily judging whether to cache a content chunk by grasping an attribute of the content chunk;
acquiring a caching probability by extracting hop count information from the content chunk judged to be cached in the primary judgment; and
secondarily judging whether to cache the content chunk based on the acquired caching probability.

2. The method of claim 1, further comprising:
storing the content chunk in a cache memory of a routing node when it is determined that the content chunk is to be cached as a result of the judgment in the secondary judgment.

3. The method of claim 2, wherein the hop count information corresponding to the content chunk is stored in the cache memory of the routing node together.

4. The method of claim 2, further comprising:
When the routing node determines to cache a received content chunk, forwarding the content chunk to a downstream network node.

5. The method of claim 1, wherein in the primary judgment, the content chunk is a part of a data packet received from an upstream routing node or a content server.

6. The method of claim 1, wherein the hop count information indicates a hop count value of the content chunk, and the caching probability is a ‘1/hop count’.

7. The method of claim 1, wherein the hop count information is acquired by using a Time To Live (TTL) value of an Internet Protocol (IP) datagram.

8. The method of claim 1, wherein the hop count information is acquired from a value indicated by a hop count field of a packet that transfers content, and the packet includes the hop count field and the content chunk.

9. The method of claim 1, wherein the primary judgment includes:
judging whether the content chunk is a target to cache by using attribute information included in the packet that transfers content;
judging whether the received content chunk is a packet that transfers general content or a control message;
judging whether the received content chunk is a packet that transfers real-time interactive content; and
judging whether the received content chunk is a packet that transfers a personal content.

10. A network entity in a network system, in order to transmit/receive content by the unit of a chunk and implement a content caching placement method, including:
a plurality of content servers;
a plurality of routing nodes; and
a plurality of user equipments,
wherein the routing node includes:
a module primarily judging whether to cache a content chunk by grasping an attribute of a content chunk received from an upstream routing node or a content server;
a module acquiring a caching probability by extracting hop count information from the content chunk judged to be cached in the primary judgment;
a module secondarily judging whether to cache the content chunk based on the acquired caching probability; and
a module storing the content chunk and the hop count information in a cache memory of a routing node when it is determined that the content chunk is to be cached as a result of the secondary judgment.

11. The network entity of claim 10, wherein the hop count information indicates a hop count value of the content chunk, and the caching probability is a ‘1/hop count’.

12. The network entity of claim 10, wherein the hop count information is acquired from a value indicated by a hop count field of a packet that transfers content, and the packet that transfers content includes the hop count field and the content chunk.

13. The network entity of claim 10, wherein the module primarily judging the routing node includes:
a module judging whether the content chunk is a target to cache by using attribute information included in the packet that transfers content;
a module judging whether the received content chunk is a packet that transfers general content or a control message;
a module judging whether the received content chunk is a packet that transfers real-time interactive content; and
a module judging whether the received content chunk is a packet that transfers a personal content.
